(19) United States
(12) Patent Application Publication
(10) Pub. No.: US 2011/0002298 A1
(43) Pub. Date: Jan. 6, 2011

(54) Reducing Overhead in Wireless Communications

(76) Inventors: Muthaiah Venkatachalam, Beaverton, OR (US); Pouya Taaghol, San Jose, CA (US)

Correspondence Address: TROP, PRUNER & HU, P.C., 1616 S. VOSS RD., SUITE 750, HOUSTON, TX, 77057-2631, US

(21) Appl. No.: 12/644,589

(22) Filed: Dec. 22, 2009

Related U.S. Application Data
(60) Provisional application No. 61/223,360, filed on Jul. 6, 2009.

(51) Int. Cl. H04W 36/10

(52) U.S. Cl. 370/331; 370/338

(57) ABSTRACT

Stations in a wireless network may communicate directly using MAC management messages. As examples, servers may communicate using MAC management messages with mobile stations, base stations may communicate using MAC management messages, and relay cells may communicate using MAC management messages.

### CROSS REFERENCE TO RELATED APPLICATIONS

This application claims priority to provisional application 61/223,360, filed Jul. 6, 2009, which application is hereby expressly incorporated herein.

### BACKGROUND

This relates generally to wireless communications and, particularly, in some embodiments, to WiMAX and WiFi wireless technologies.

Wireless transceivers, generally called mobile stations, communicate in wireless networks with base stations which, in turn, communicate with access service networks (ASNs) and core networks (CNs). Normal communications between mobile stations and network servers may be complicated by the fact that network servers have difficultly pushing information to mobile stations. This is because mobile stations generally have firewalls that prevent communications with entities not having an ongoing session. Thus, where a network server wishes to push information to a mobile station, it runs into the problem that the mobile station may not accept the communication because it will be blocked by its firewall.

In many cases, communications with mobile stations must go through Internet Protocol packet processing and must transit a firewall. This sometimes adds overhead to the communications.

### BRIEF DESCRIPTION OF THE DRAWINGS

FIG. 1 is a depiction of a communication between two relay cells in accordance with one embodiment;

FIG. 2 is a depiction of a communication between a location server and a mobile station in accordance with one embodiment;

FIG. 3 is a depiction of a communication between an inter-technology handoff server and a mobile station in accordance with one embodiment;

FIG. 4 is a depiction of a communication between a bootstrap server and a mobile station in accordance with one embodiment;

FIG. 5 is a depiction of a communication between a simple message system server and a mobile station in accordance with one embodiment;

FIG. 6 is a depiction of a transfer packet in accordance with one embodiment;

FIG. 7 is a flow chart for one embodiment; and

FIG. 8 is a schematic depiction of a mobile station in accordance with one embodiment.

### DETAILED DESCRIPTION

In accordance with some embodiments, communications between base stations and between network servers and mobile stations may be implemented through one of two transfer mechanisms. The first transfer mechanism, referred to herein as an L3 transfer mechanism, is conventional in that it takes place in the case of a mobile station or a base station through a firewall to an Internet Protocol or L3 layer. This involves firewall processing and Internet Protocol packet processing. However, some communications may be by a second mechanism, called an L2 transfer herein, wherein the packets transfer between medium access control (MAC) or L2 layer in the mobile station and the network server or between MAC layers of base stations using a MAC control message, sometimes also called a MAC management message. These L2 transfers have many advantages, in some embodiments, including the fact that they avoid the transiting of the firewall and the processing of Internet Protocol packets. In some cases, the L2 transfer enables network servers to communicate directly with mobile stations without first having established a session.

As used herein, a wireless station includes any end point in a wireless network that is capable of receiving wireless messages. The term “station” includes mobile stations, base stations, and servers in the ASN or CN.

In some embodiments of the present invention, a wireless system complying with the WiMAX standard may be used. (IEEE std. 802.16-2004, IEEE Standard for Local and Metropolitan Area Networks, Part 16: Interface for Fixed Broadband Wireless Access Systems, IEEE New York, N.Y. 10016). In some embodiments, other wireless standards may also be used, including the WiFi standard. (IEEE Std. 802.11 (1999-07-015) Wireless LAN Medium Access Control (MAC) and Physical Layer Specifications). Still other embodiments may comply with the 3GPP Evolved Universal Terrestrial Radio Access; Long Term Evolution (LTE) TS36-201 (Dec. 9, 2009) standard available from 3GPP Mobile Competence Center, 06921 Sophia-Antipolis, Cedex, France. It may include personal area networks, metropolitan area networks, and, in fact, networks of any particular size.

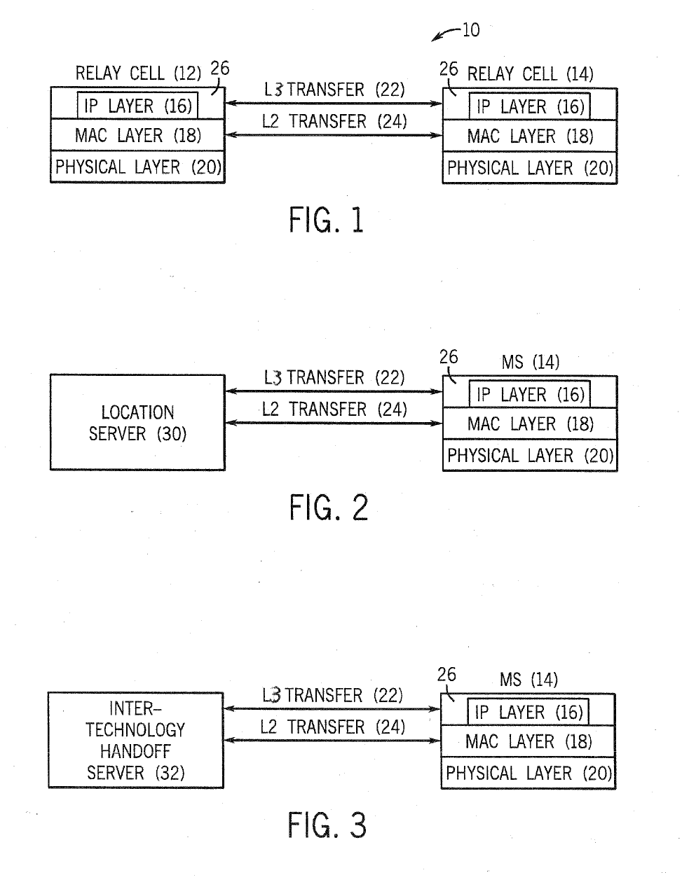

Referring to FIG. 1, a communication between a first relay cell 12 and a second relay cell 14 in a network 10 is depicted. A relay is a type of cell that uses an in-band WiMAX backhaul or out-of-band WiMAX backhaul. Generally, a relay station relays communications from a mobile station to a base station. However, in some cases, relay stations may communicate with other relay stations. The cells 12 and 14 include an Internet Protocol (IP) layer 16, a medium access control (MAC) layer 18, and a physical layer 20. A firewall 26 may protect the layer 16.

Relay messages may be communicated between the two relay cells through an L2 transfer 24 via their respective MAC layers 18. The L2 transfer may be used, for example, for relay control messages. In addition, conventional L3 transfer 22 may also be used.

In addition, a relay station may communicate with an access service network (ASN) gateway. These messages may be transferred over an L2 transfer mechanism between a relay station and a base station. In the downlink, the base station performs classification, removes the higher layer headers, keeps the message contents in tact, and sends the message using the L2 transfer, addressed to the station identifier (STID) of the relay station and with a flow identifier (FID) equal to a preset value (e.g. one). In the uplink, the relay station sends the message using an L2 transfer to the base station with FID equal to a preset value (e.g. one).

Referring to FIG. 2, a communication between a location server 30 and a mobile station (MS) 14 is depicted. The location server may also be part of the CN. Again, an L3 transfer 22 is possible between a location server 30 and an Internet Protocol layer 16, but such a transfer must transition through the firewall 26. An L2 transfer 24 does not transition through the firewall 26; it goes directly to the MAC layer 18. The location server may be any server that provides global positioning system or location assistance to a mobile station. It may comply with any of a variety of standards, including European Global Navigation Satellite System, also called Galileo, (GNSS), global positioning (GPS), and Russia's Global Orbiting Navigation Satellite System (GLONASS) assistance on the downlink. In addition, it may include location-based service (LBS) measurements, such as terrestrial measurements and GNSS pseudo ranges on the uplink.

The location server communicates by either the L3 or the L2 transfer, as selected in the packet header. Each of these transfers through an intervening base station. However, in the L2 transfer, there is no processing, necessarily, in some embodiments, in the base station, but, instead, the base station simply receives and forwards the message.

In this case, the MAC management message (of an L2 transfer 24) acts as a generic service carrier for various services, including geo-location unicast delivery to the mobile station from a base station, media-independent handover (MIH) transfer, messaging service, and the like.

Referring to FIG. 3, a communication between an inter-technology handoff server 32 and the mobile station 14 also can proceed by way of either an L3 transfer 22 or an L2 transfer 24. The inter-technology handoff server may be part of the CN or ASN. The inter-technology handoff server generally has two types of communication. The first type is for WirelessMAN-OFDMA network boundary indications on the downlink. See IEEE Std. 802.16e/D5-2004. When a mobile station is near a network boundary, the server 32 will notify the mobile station that it should prepare for handoff. In addition, the inter-technology handoff server handles actual communication of handoff messages using what is called ORT-MSG in the downlink. The various types of such messages include Global System for Mobile Communications (GSM), EDGE Radio Access Network (GERAN), Universal Mobile Telecommunications System (UMTS), Terrestrial Radio Access Network (UTRAN), Evolved UTRAN (E-UTRAN), Time Division Synchronous Code Division Multiple Access (TD-SCDMA), Code Division Multiple Access Code (CDMA-2000), and WiFi.

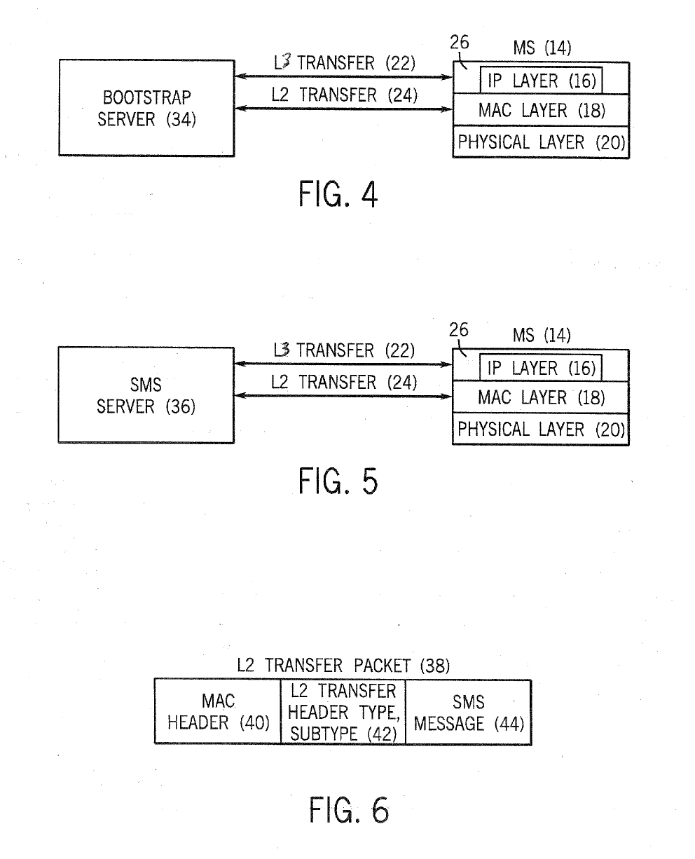

Referring to FIG. 4, a bootstrap server 34 may also communicate by either an L3 transfer 22 or an L2 transfer 24 with a mobile station 14. In one embodiment, the bootstrap server may be in the CN. A bootstrap server 34 is a server that initiates a new mobile station with an operator or carrier. The communication from the server 34 to the mobile station 14 may include device provisioning or providing credentials to make the device recognized by the network. The payload of the MAC management message may be an actual bootstrap file or a link to a bootstrap file in the core network.

In this case, because the mobile station is a new device not recognized, it can never communicate with any base station to reach the bootstrap server because the base station would not have established a session with the mobile station. This allows initiation of a communication from the mobile station with the base station and, ultimately, the bootstrap server, using the MAC management message. In addition, the server 34 can push configuration information to the mobile station without the mobile station first initiating a session.

Similarly, a simple message service (SMS) server 36 may communicate with a mobile station 14 using an L3 transfer 22 or an L2 transfer 24, as shown in FIG. 5. An example of the MAC management layer or L2 transfer packet 38 is shown in FIG. 6. It may include a SMS message 44 and a MAC header 40, which is recognized by the receiving device and, particularly, in some embodiments, by its packet data convergence protocol (PDCP) layer, which reads the header 40 and forwards the header directly to the MAC layer 18. At the MAC layer, the appropriate L2 transfer header is detected and read. Also provided at 42 is the type of L2 transfer and the sub-type. In one embodiment, the types may be a transfer type 1, which is a GNSS assistance message on the downlink. Under type 1 may be a sub-type 1 which is a GPS message or a sub-type 2 which is a Galileo message. Transfer type 2 is LBS measurements that are uplink measurements. Transfer type 3 is a device bootstrap which may be a downlink or an unlink message. Type 4 is a WirelessMAN-OFDMA network boundary indication on the downlink channel. Type 5 is an ORAT-MSG downlink message. Sub-type 1 is a GERAN message, sub-type 2 is a UTRAN message, sub-type 3 is an E-UTRAN message, sub-type 4 is a TDSCDMA message, sub-type 5 is a CDMA 2000 message, and sub-type 6 is a WiFi message. Transfer type 6 may be used for the MS uplink or downlink messages. A device can also use type 6 for a given device to talk to a network server. Type 7 is used for the relay control messages.

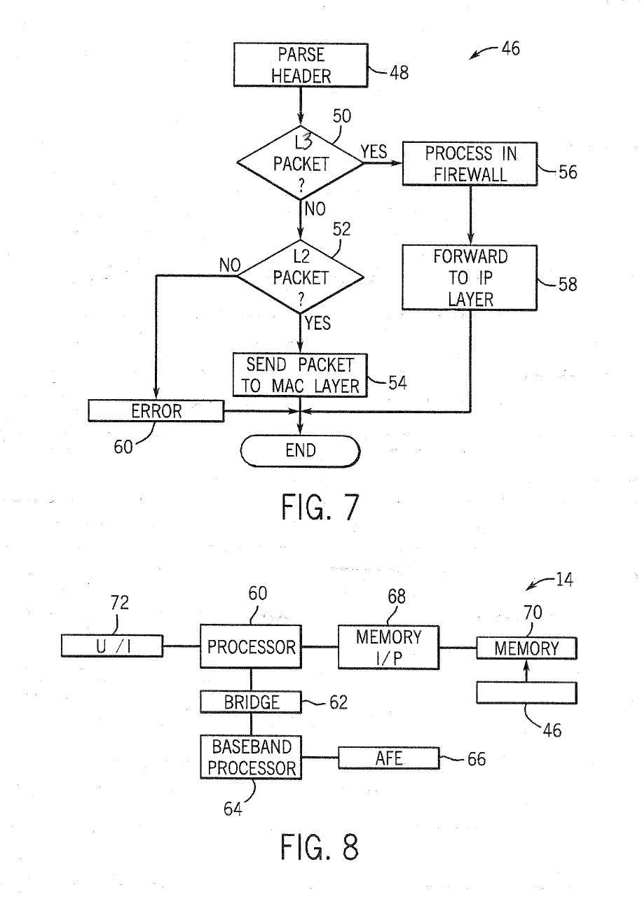

Referring to FIG. 7, a sequence 46 may enable selection use of either L3 or L2 transfer protocols. The sequence may be implemented in software, hardware, or firmware. In a software embodiment, it may be implemented by instructions stored within a computer readable medium, such as a semiconductor, optical, or magnetic storage medium. Those instructions may be executed by a processor, controller, or computer.

Initially, at block 48, a packet header may be parsed, for example, by the PDCP layer. If that header indicates that an L3 transfer protocol is being used, as determined in diamond 50, the package is processed through the firewall, as indicated in block 56. Then it is forwarded to the Internet Protocol layer, as indicated in block 58.

If it is not an L3 packet, then a check at diamond 52 determines whether it is an L2 packet. If so, the packet is sent directly to the MAC layer, because it was recognized as a MAC management message, as indicated in block 54. If it is not an L2 packet, then there is an error and an error message may be indicated as suggested in block 60.

Referring to FIG. 8, the mobile station 14 may include a processor 60, coupled through a bridge 62, to a baseband processor 64. The baseband processor may be coupled to an analog front end (AFE) 66. Other architectures may also be used.

The processor 60 may be coupled to a user interface (U/I) 72 and a memory interface 68. The memory interface 68 may be coupled to a memory 70. In one embodiment, where the sequence shown in FIG. 7 is implemented in software, the instructions to implement the sequence 46 may be stored in the memory 70, as one example.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
enabling a mobile station to communicate with a server using a MAC control message.

2. The method of claim 1 including allowing two relay cells to communicate through a MAC control message.

3. The method of claim 1 including enabling a location server to communicate with a mobile station using MAC control message.

4. The method of claim 1 including enabling an inter-technology handoff server to communicate with a mobile station using a MAC control message.

5. The method of claim 1 including enabling a bootstrap server to communicate with a mobile station using a MAC control message.

6. The method of claim 1 including enabling a simple message service server to communicate with a mobile station using a MAC control message.

7. The method of claim 1 including enabling two base stations to communicate using a MAC control message.

8. The method of claim 1 including providing a MAC control message with a MAC header, a transfer type and sub-type, and a payload.

9. The method of claim 1 including parsing a header on a packet to determine whether the packet is being transferred pursuant to a protocol using MAC control messages or not.

10. The method of claim 8 including determining that the message is not a MAC control message and providing the message to an Internet Protocol layer.

11. The method of claim 8 including determining that the packet is a MAC control message and providing the packet to a MAC layer.

12. A mobile station comprising:
a physical layer;
a medium access control layer;
an Internet Protocol layer; and
said mobile station to communicate with a server using a medium access control control message.

13. The station of claim 12 wherein said mobile station to communicate with a location server using a medium access control control message.

14. The station of claim 12, said mobile station to communicate with an inter-technology handoff server using a medium access control control message.

15. The station of claim 12, said mobile station to communicate with a bootstrap server using a medium access control control message.

16. The station of claim 12 to communicate with a simple message service server using a medium access control control message.

17. The station of claim 12, said medium access control layer to develop a medium access control control message include a medium access control header, a transfer type and sub-type, and a payload.

18. The station of claim 12, said station to parse a receive packet to determine whether the packet is being transferred pursuant to a protocol using a medium access control control message or not.

19. The station of claim 18, said station to provide to message to an Internet Protocol layer if the message is not a medium access control control message.

20. A server for a wireless network comprising:
a physical layer;
a medium access control layer;
an Internet Protocol layer; and
said server to communicate with a mobile station using a medium access control control message.

21. The server of claim 20 wherein said server is a location server.

22. The server of claim 20 wherein said server is an inter-technology handoff server.

23. The server of claim 20 wherein said server is a bootstrap server.

24. The server of claim 20 wherein said server is a simple message service server.

25. The server of claim 20, said medium access control layer to develop a medium access control control message include a medium access control header, a transfer type and sub-type, and a payload.

26. The server of claim 20, said server to parse a receive packet to determine whether the packet is being transferred pursuant to a protocol using a medium access control control message or not.

27. The server of claim 20, said server to provide to message to an Internet Protocol layer if the message is not a medium access control control message.

28. A base station for a wireless network comprising:
a physical layer;
a medium access control layer;
an Internet Protocol layer; and
said base station to communicate with another base station using a medium access control control message.

29. The station of claim 28, said medium access control layer to develop a medium access control control message include a medium access control header, a transfer type and sub-type, and a payload.

30. The station of claim 28, said station to parse a receive packet to determine whether the packet is being transferred pursuant to a protocol using a medium access control control message or not.

31. The station of claim 30, said station to provide to message to an Internet Protocol layer if the message is not a medium access control control message.

32. A wireless relay cell comprising:
a physical layer;
a medium access control layer;
an Internet Protocol layer; and
said relay cell to communication with another relay cell using a medium access control control message.

33. The relay cell of claim 32, said medium access control layer to develop a medium access control control message include a medium access control header, a transfer type and sub-type, and a payload.

34. The relay cell of claim 32, said relay cell to parse a receive packet to determine whether the packet is being transferred pursuant to a protocol using a medium access control control message or not.

35. The relay cell of claim 34, said relay cell to provide to message to an Internet Protocol layer if the message is not a medium access control control message.
